(19) United States
(12) Patent Application Publication
(10) Pub. No.: US 2016/0093973 A1
(43) Pub. Date: Mar. 31, 2016

(54) CONNECTOR COUPLING STRUCTURE

(71) Applicant: FANUC Corporation, Yamanashi (JP)

(72) Inventor: Kazuhiko HIRANO, Yamanashi (JP)

(21) Appl. No.: 14/858,016

(22) Filed: Sep. 18, 2015

(30) Foreign Application Priority Data
Sep. 26, 2014 (JP) 2014-196677

(51) Int. Cl. H01R 13/514

(52) U.S. Cl. CPC H01R 13/514

(57) ABSTRACT

A distribution cable connector includes a cable and a plurality of distribution connectors that are connected to the cable and are used to connect the cable to a connection destination connector. Each of the distribution connectors includes a connection part configured to be fit into the connection destination connector and a fitting part with which a connection part of another distribution connector can be engaged. The distribution connector is configured to be connected to the connection destination connector via the connection part of the distribution connector and to be coupled to another distribution connector through engagement with a fitting part of the other distribution connector.

### BACKGROUND OF THE INVENTION

1. Field of the Invention

The present invention relates to a distribution cable connector that is configured with a cable and a plurality of distribution connectors connected to the cable, and more particularly to a distribution cable connector in which each of the distribution connectors has a structure that can be coupled to another distribution connector.

2. Description of the Related Art

One of operations required in assembly processes and the like for various devices is an operation for connecting a distribution connector of a distribution cable connector to a connection destination connector. An example of a distribution cable connector in a prior art technique will now be described with reference to FIG. 10.

A distribution cable connector is configured with a cable 2 and a plurality of distribution connectors 1 connected to the cable 2. The distribution connectors 1 have a role in connecting the cable 2 to a connection destination connector (counterpart connector 21). In FIG. 10, a representation of the middle part of the cable 2 is simplified with a dashed-two dotted line. The counterpart connector 21 is fixed on a printed circuit board 20. To the counterpart connector 21, each of the distribution connectors 1 of the distribution cable connector is connected via a connection part 3 formed in the distribution connector 1.

In such a distribution cable connector, the distribution connector 1 that has not yet been connected to the counterpart connector 21 (the distribution connector 1 drawn on the left in FIG. 10) is in the air, not positioned. Therefore, for automatic assembly with a robot or the like, if an attempt is made to hold the distribution connector 1, the holding operation (handling) is not easy to perform. Thus, in the prior art technique, as illustrated in FIG. 10, an adapter or a clamp member 30 is set up, which is a place for temporarily fixing the distribution connector 1 to be subjected to robot handling (the distribution connector 1 drawn on the right in FIG. 10), and the distribution connector 1 is positioned before the distribution connector 1 is connected to the counterpart connector 21, thereby enabling handling by the robot.

As a prior art technique, Japanese Patent Application Laid-Open No. 2001-177950 discloses a technique by which each of a plurality of electric connection boxes electrically connected to a cable is provided with a first frame part and a second frame part, and in the first frame part of one electric connection box, the second frame part of another electric connection box is fit, thereby enabling mutual coupling of the plurality of electric connection boxes.

However, the prior art technique above is merely a technique by which a plurality of electric connection boxes are configured so that the electric connection boxes can be mutually coupled and it is therefore possible to respond to a machine configuration change or the like. The technique does not suggest any solutions to the above problem in handling of the distribution cable connector by the robot in automatic assembly.

In a factory in which a robot handles a distribution cable connector and automatically connects a distribution connector of the distribution cable connector to a counterpart connector, it is important to temporarily fix the distribution connector in a predetermined place before the distribution connector is connected to the counterpart connector. To do so, however, there is a problem in that a place for temporarily fixing the unconnected distribution connector is required, a waste of man-hours and components is produced, and costs cannot be minimized.

### SUMMARY OF THE INVENTION

An object of the present invention is to provide a distribution cable connector that is configured so that, when a robot handles the distribution cable connector and connects a distribution connector of the distribution cable connector to a counterpart connector, there is no need to separately provide a place in which the unconnected distribution connector can be temporarily fixed and there is no need to provide a component for setting up a place for temporary fixing.

A distribution cable connector according to the present invention includes a cable and a plurality of distribution connectors that are connected to the cable and are used to connect the cable to a connection destination connector. Each of the distribution connectors of the distribution cable connector includes a connection part configured to be fit into the connection destination connector and a fitting part that is formed on a side opposite to a side on which the connection part is disposed and with which a connection part of another distribution connector can be engaged. The distribution connector is configured to be connected to the connection destination connector via the connection part of the distribution connector and to be coupled to another distribution connector through engagement with a fitting part of the other distribution connector.

The distribution connector may include a connecting hook and an engagement part with which a connecting hook of another distribution connector is further engaged. In this case, the connecting hook may be disposed on one of surfaces of the distribution cable other than a surface on the side on which the connection part of the distribution connector is disposed and a surface on the side opposite to the side on which the connection part is disposed. On the surface on the side opposite to the side on which the connection part of the distribution connector is disposed, a connecting hook retaining part may be provided by which when another distribution connector is coupled, a connecting hook of the other distribution connector is retained.

The distribution connector may have a structure that enables a plurality of distribution connectors to be fit one on top of another. The fitting part of the distribution connector may have a mechanism that locks a fitting state of the plurality of distribution connectors by a movable hook. The distribution connector may have a mechanism that can attach and detach only the topmost distribution connector when the plurality of distribution connectors are fit one on top of another.

A distribution connector according to the present invention is connected to a cable and is used to connect the cable to a connection destination connector. The distribution connector includes a connection part that is fit into the connection destination connector and a fitting part that is formed on a side opposite to a side on which the connection part is disposed and with which a connection part of another distribution connector can be engaged. The distribution connector is configured to be connected to the connection destination connector via the connection part of the distribution connector and to be coupled to another distribution connector through engagement with a fitting part of the other distribution connector.

In the present invention, when a robot handles a distribution cable connector and connects a distribution connector of the distribution cable connector to a counterpart connector, there is no need to separately set up a place in which the unconnected distribution connector can be temporarily fixed, there is no need to provide a component for setting up a place for temporary fixing, and therefore automation in an assembly factory is facilitated while keeping costs low.

### BRIEF DESCRIPTION OF THE DRAWINGS

The above and other objects and features of the present invention will be apparent from the following description of embodiments with reference to the appended drawings, in which:

FIG. 1 is a perspective view illustrating a first embodiment of a distribution cable connector according to the present invention;

FIG. 2 illustrates that a plurality of distribution connectors can be mutually coupled by fitting a connection part of a distribution connector in FIG. 1 in a housing rear part of another distribution connector;

FIG. 3 is a perspective view illustrating a state in which two distribution connectors connected to both ends of a cable in FIG. 1 are coupled one above the other;

FIG. 4 is a side view of the two distribution connectors coupled one above the other in FIG. 3;

FIG. 5 is a perspective view illustrating a second embodiment of a distribution cable connector according to the present invention;

FIG. 6 is a cross-sectional view of FIG. 5 taken along the arrowed line A-A′;

FIG. 7 is a perspective view illustrating a third embodiment of a distribution cable connector according to the present invention;

FIG. 8 is a perspective view of the distribution cable connector in FIG. 7 viewed from another direction;

FIG. 9 is an enlarged view of a distribution connector of the distribution cable connector in FIG. 7; and

FIG. 10 illustrates an example of a distribution cable connector in a prior art technique.

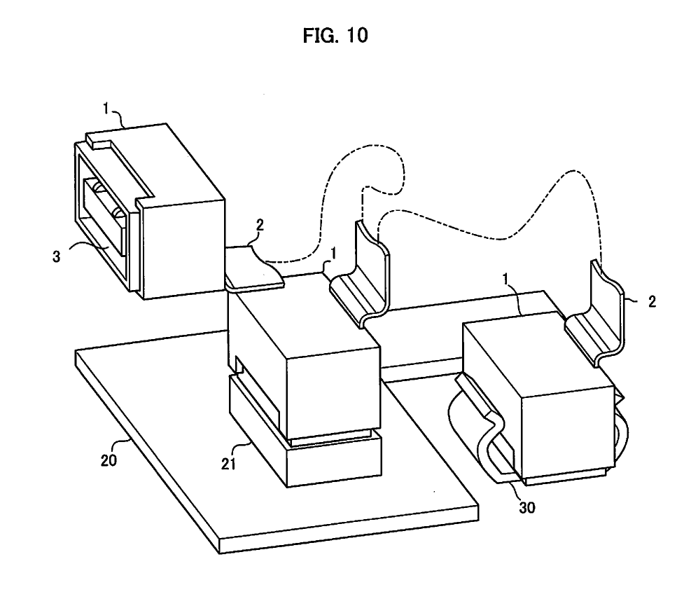

### DETAILED DESCRIPTION OF THE PREFERRED EMBODIMENTS

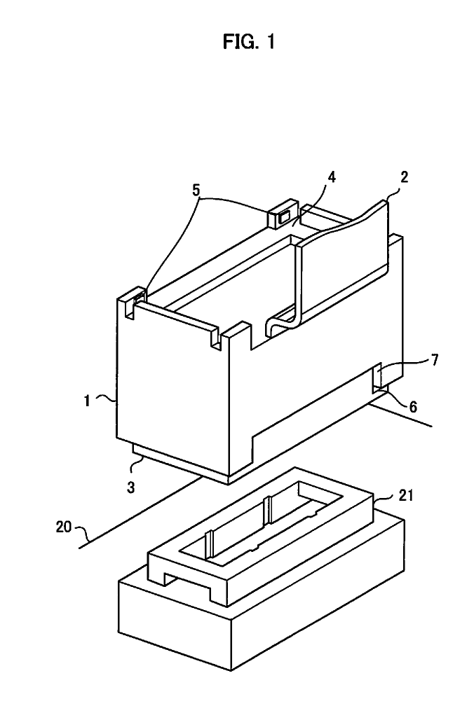

A first embodiment of a distribution cable connector according to the present invention will first be described with reference to FIGS. 1 to 4.

FIG. 1 is a perspective view illustrating the first embodiment of the distribution cable connector according to the present invention.

The distribution cable connector includes a cable 2 (cut at the middle in the drawing) and a distribution connector 1 connected to the cable 2. The distribution connector 1 includes a connection part 3. The distribution connector 1 is configured to be connected to a counterpart connector 21 disposed on a printed circuit board 20 via the connection part 3. The distribution connector 1 has a housing rear part 4 formed on a surface on a side opposite to a side on which the connection part 3 is disposed. The cable 2 is connected to the housing rear part 4, and is connected to a terminal (not shown) disposed in the connection part 3 in the inside of the distribution connector 1. When the connection part 3 is connected to the counterpart connector 21 disposed on the printed circuit board 20, the cable 2 and the terminal (not shown) of the counterpart connector 21 are brought into conduction.

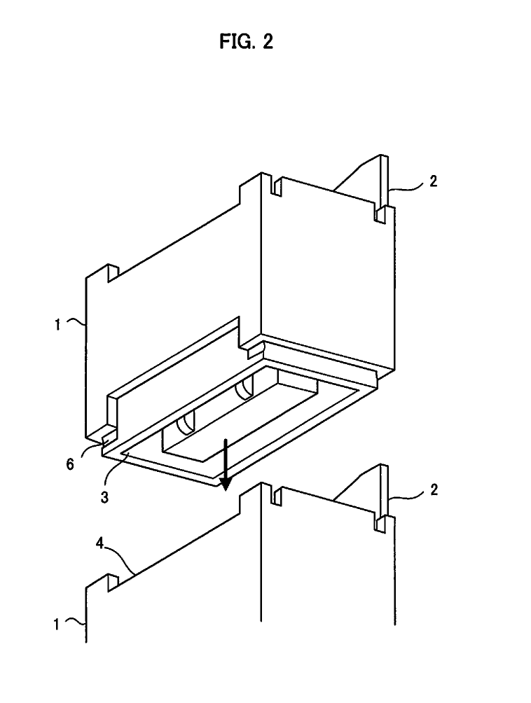

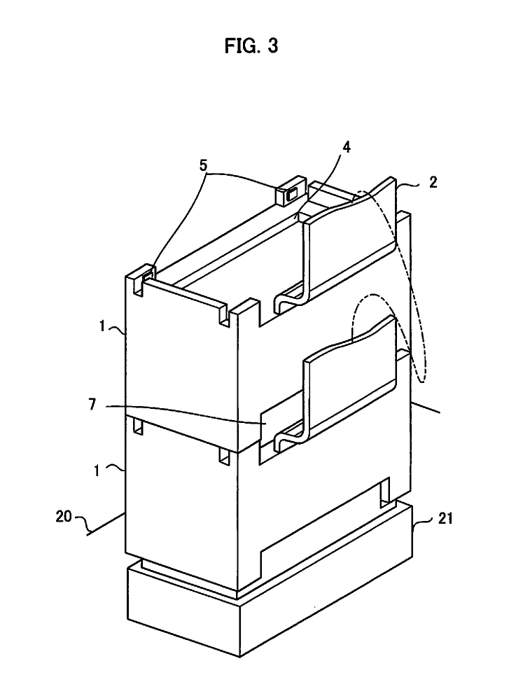

The housing rear part 4 of the distribution connector 1 is so configured that the connection part 3 of another distribution connector 1 (not shown) may be fit into the housing rear part 4. As illustrated in FIG. 2, when the connection part 3 of the distribution connector 1 is fit into the housing rear part 4 of another distribution connector 1, a plurality of distribution connectors 1 can be mutually coupled. When the distribution connectors 1 are coupled each other, a retaining protrusion 5 (FIG. 3) disposed in the housing rear part 4 of one distribution connector 1 and a retaining recess 6 disposed in the connection part 3 of the other distribution connector 1 are engaged, thereby maintaining a coupling state of the distribution connectors 1 with stability. In addition, the height and the shape of the retaining protrusions 5 are adjusted so that when force is applied from the outside to the plurality of mutually coupled distribution connectors 1, the housing rear part 4 of one distribution connector 1 can be easily detached from the connection part 3 of the other distribution connector 1.

A notch 7 is disposed near the connection part 3 of the distribution connector 1. When the distribution connector 1 is coupled to another distribution connector 1, the notch 7 prevents the periphery of the connection part 3 of the upper distribution connector 1 from interfering with the cable 2 of the lower distribution connector 1.

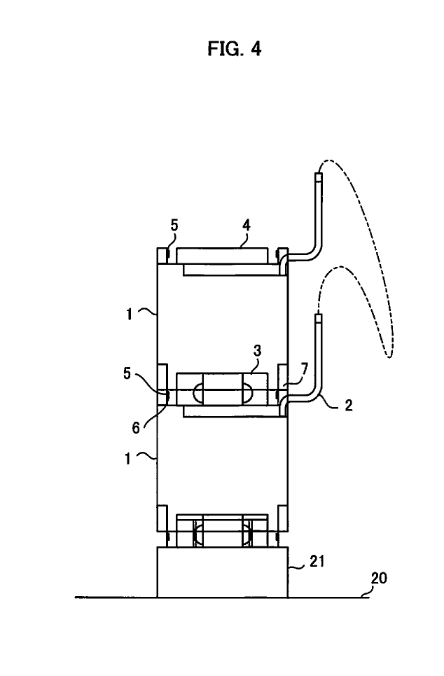

FIG. 3 is a perspective view illustrating a state in which two distribution connectors 1 connected to both ends of the cable 2 are coupled one above the other. The connection part 3 of the upper distribution connector 1 is fit into the housing rear part 4 of the lower distribution connector 1. FIG. 4 is a side view of the two distribution connectors 1 coupled one above the other in FIG. 3.

In the embodiment of the present invention, as illustrated in FIGS. 3 and 4, in a state where the distribution connector 1 connected to one end of the cable 2 has been connected to the counterpart connector 21 on the printed circuit board 20, when the distribution connector 1 (unconnected distribution connector 1) that has not yet been connected to the counterpart connector 21 is fit into the housing rear part 4 of the distribution connector 1 (connected distribution connector 1) that has been connected to the counterpart connector 21 to couple the distribution connectors 1, the unconnected distribution connector 1 can be positioned during assembly. This makes it easier for a robot to handle the distribution connectors 1 and prevents the unconnected distribution connector 1 from inhibiting the robot behavior in an assembly operation.

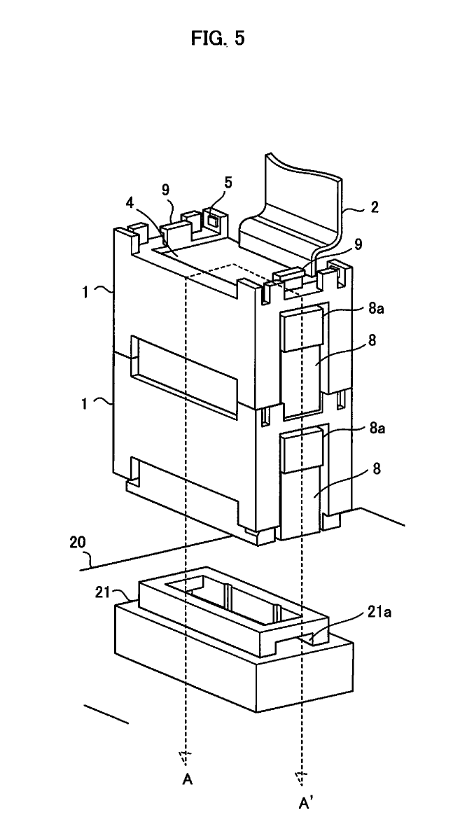

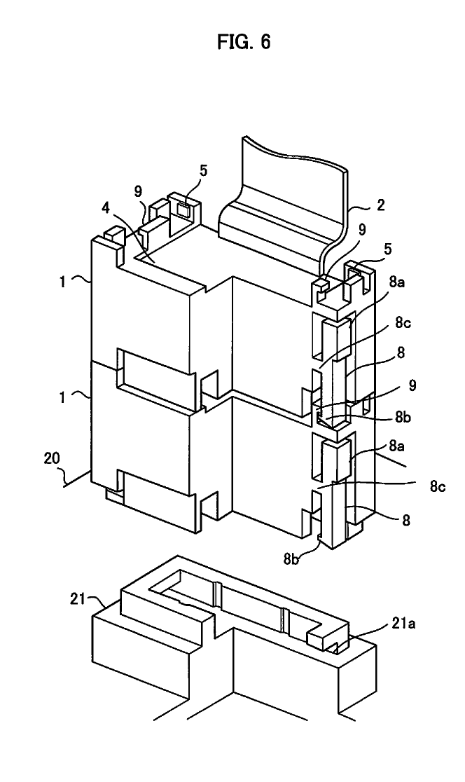

A second embodiment of a distribution cable connector according to the present invention will next be described with reference to FIGS. 5 and 6.

The distribution connector 1 of the distribution cable connector according to this embodiment has a structure in which a connection locking hook member 8 is added to the distribution connector 1 of the distribution cable connector according to the first embodiment. As illustrated in FIG. 6, the connection locking hook member 8 is a prismatic member that has a connection unlocking push part 8a at one end (top end) and a connection locking hook 8b at the other end (bottom end). The connection locking hook member 8 is fixed at the substantially intermediate position in the length direction to a side surface of the distribution connector 1 by a hook member support part 8c. The hook member support part 8c is made of an elastic resin or the like. When force is not applied from the outside, a side surface of the connection locking hook member 8 is maintained in parallel with the side surface of the distribution connector 1.

On the other hand, a retaining recess 21a is formed on a side surface of the counterpart connector 21 on the printed circuit board 20 at a position that matches the connection locking hook 8b of the connection locking hook member 8 when the distribution connector 1 is connected to the counterpart connector 21. Therefore, when the distribution connector 1 is connected to the counterpart connector 21, the connection locking hook 8b of the distribution connector 1 is retained in the retaining recess 21a of the counterpart connector 21, thereby locking a connection state of the distribution connector 1 and the counterpart connector 21.

Moreover, a connecting hook retaining part 9 is disposed in the housing rear part 4 of the distribution connector 1 at a position that matches the connection locking hook 8b of another distribution connector 1 when the other distribution connector 1 is coupled to this distribution connector 1. Therefore, when two distribution connectors 1 are coupled, the connection locking hook 8b of the upper distribution connector 1 and the connecting hook retaining part 9 of the lower distribution connector 1 are engaged with each other, locking a coupling state of the upper and lower distribution connectors.

When the connection unlocking push part 8a of the distribution connector 1 connected to the counterpart connector 21 or coupled to another distribution connector 1 is pushed toward the inside of the distribution connector 1, the connection locking hook member 8 is tilted with the hook member support part 8c, which is made of an elastic member, as the center of the tilt, thereby unlocking the coupling state of the distribution connectors 1 by means of the connection locking hook 8b and the connecting hook retaining part 9 or the connection state of the distribution connector 1 and the counterpart connector 21 by the connection locking hook 8b and the retaining recess 21a. Then, when the distribution connector 1 is lifted, the connection state or the coupling state can be released.

Once such a configuration is provided, when a robot handles a plurality of coupled distribution connectors 1, the connection unlocking push part 8a of the desired connection locking hook member 8 is pushed, and then the desired distribution connector 1 can be detached and handled.

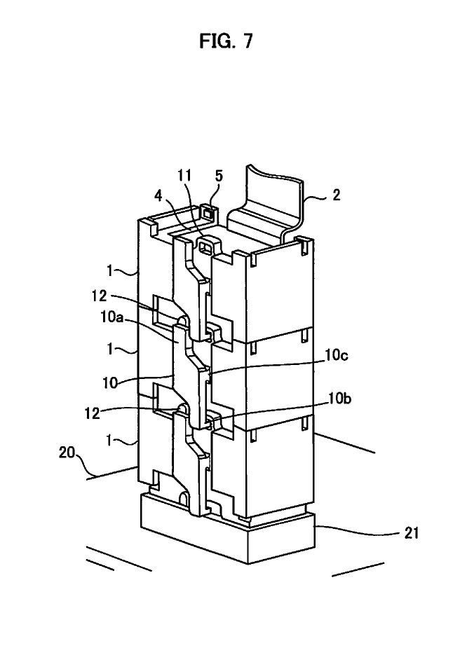

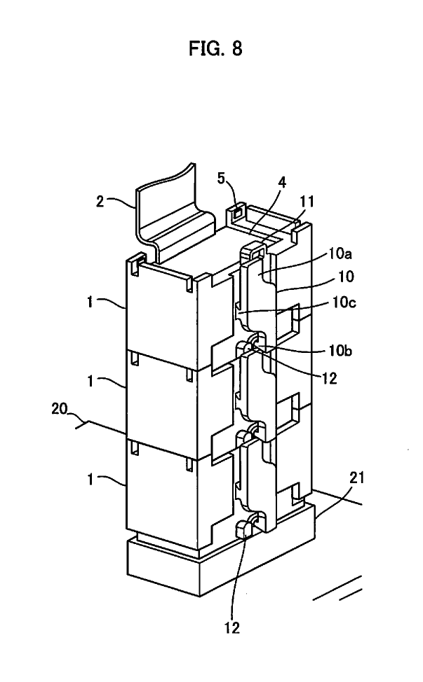

A third embodiment of a distribution cable connector according to the present invention will next be described with reference to FIGS. 7 to 9.

The distribution connector 1 of the distribution cable connector according to this embodiment has a structure in which an automatic coupling locking retractable lever 10 is added to the distribution connector 1 of the distribution cable connector according to the first embodiment. The automatic coupling locking retractable lever 10 is a member that has a force point part 10a at one end (top end) and a coupling hook 10b at the other end (bottom end). The automatic coupling locking retractable lever 10 is fixed at the substantially central position to a side surface of the distribution connector 1 by a lever support part 10c. The force point part 10a of the automatic coupling locking retractable lever 10 is long enough to protrude from the top end of the distribution connector 1. Therefore, when another distribution connector 1 is coupled to this distribution connector 1, the automatic coupling locking retractable lever 10 reaches the position of the connection part 3 of the distribution connector 1 above the automatic coupling locking retractable lever 10. The lever support part 10c, which fixes the automatic coupling locking retractable lever 10 to the distribution connector 1, is made of an elastic resin or the like. When force is not applied from the outside, the automatic coupling locking retractable lever 10 is maintained in parallel with the side surface of the distribution connector 1.

On the other hand, a retaining recess 11 is disposed in the housing rear part 4 of the distribution connector 1 at a position that matches the coupling hook 10b of another distribution connector 1 when the other distribution connector 1 is coupled to the housing rear part 4. Therefore, when two distribution connectors 1 are coupled, the coupling hook 10b of the upper distribution connector 1 comes near the retaining recess 11 of the lower distribution connector 1.

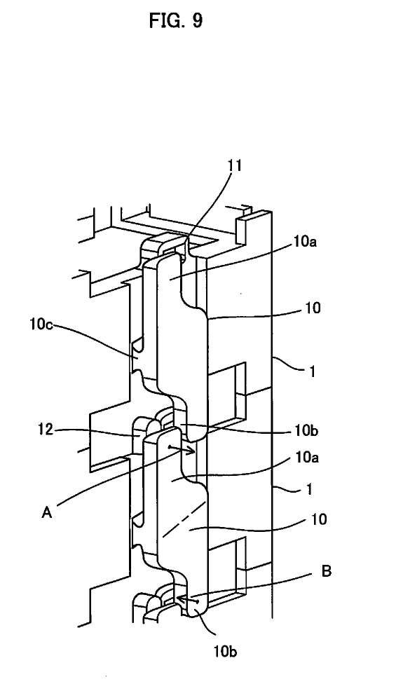

Moreover, a push-out part 12 is disposed in a side surface of the connection part 3 of the distribution connector 1 at a position that matches the force point part 10a of the lower distribution connector 1 when another distribution connector 1 is coupled to this distribution connector 1. Therefore, when two distribution connectors 1 are coupled one above the other as illustrated in FIG. 9, the push-out part 12 of the upper distribution connector 1 pushes out the force point part 10a of the lower distribution connector 1 from the inside of the distribution connector 1 toward the outside (in the direction denoted by the arrow A in FIG. 9).

When the force point part 10a of the lower distribution connector 1 is pushed out toward the outside of the lower distribution connector 1, the automatic coupling locking retractable lever 10 of the distribution connector 1 is tilted with the lever support part 10c serving as the fulcrum of the tilt. As a result, the coupling hook 10b is moved in the direction of the inside of the distribution connector 1 (in the direction denoted by the arrow B in FIG. 9) and meshed with the retaining recess 11 of the further lower distribution connector 1, and a coupling state is automatically locked.

Thus, in the case of the distribution cable connector according to the present embodiment, when a plurality of distribution connectors 1 of the distribution cable connector are coupled, coupling of the second or lower distribution connectors 1 from the top and the further lower distribution connector 1 is locked by the automatic coupling locking retractable lever 10. Therefore, when a robot handles the plurality of coupled distribution connectors 1, the distribution connectors 1 other than the topmost distribution connector 1 are not detached by any means, and the accuracy of automatic assembly can be improved.

As a variation of the third embodiment, a configuration may be provided in which the size of the coupling hook 10b and the positioning of the retaining recess 11 are adjusted so that when two distribution connectors 1 are coupled each other, the coupling hook 10b of the upper distribution connector 1 and the retaining recess 11 of the lower distribution connector 1 are engaged with each other to couple the distribution connectors 1. In this case, to detach the upper distribution connector 1 from the lower distribution connector 1, the force point part 10a of the upper distribution connector 1 is pushed into the inside of the distribution connector 1 and thereby the automatic coupling locking retractable lever 10 is tilted with the lever support part 10c serving as the center of the tilt. Then, the state of engagement of the coupling hook 10b with the retaining recess 11 is released, and the distribution connector 1 can be detached from the other distribution connector 1.

Also in such a configuration, when a plurality of distribution connectors 1 are coupled, the force point part 10a of each of the second and lower distribution connectors 1 from the top has the push-out part 12 of the upper distribution connector 1 positioned in the inside. Therefore, this prevents the force point part 10a from being pushed into the inside and leads to a kind of coupling lock state, and the distribution connector 1 cannot be detached from the other distribution connector 1.

Once such a configuration is provided, when a robot handles a plurality of coupled distribution connectors 1, the distribution connectors 1 other than the topmost distribution connector 1 can be prevented from being detached, and the accuracy of automatic assembly with the robot can be improved.

The embodiments of the present invention have been described above, but the present invention is not limited to the examples of the above embodiments, and can be implemented in other aspects by making appropriate changes. For example, the drawings illustrate examples of the shape of the distribution connector in the case where the connection part 3 of the distribution connector 1 is recessed and the counterpart connector 21 is protruded. However, even when the connection part 3 of the distribution connector 1 is protruded and the counterpart connector 21 is recessed, the present invention can be applied by forming the housing rear part 4 of the distribution connector 1 to conform to the shape of the connection part 3.

The cable 2 has been described as being connected to the housing rear part 4 of the distribution connector 1. However, for example, even when the distribution connector is of a type in which the cable 2 is connected to a side surface of the distribution connector 1, the present invention can be applied. Further, for the connection locking hook member 8, the automatic coupling locking retractable lever 10, and the retaining members, the shapes illustrated in the drawings can be changed as appropriate within a design scope.

1. A distribution cable connector comprising:
a cable; and
a plurality of distribution connectors that are connected to the cable and are used to connect the cable to a connection destination connector, each of the distribution connectors including:
a connection part configured to be fit into the connection destination connector; and
a fitting part that is formed on a side opposite to a side on which the connection part is disposed and with which a connection part of another distribution connector can be engaged,
wherein the distribution connector is configured to be connected to the connection destination connector via the connection part of the distribution connector and to be coupled to another distribution connector through engagement with a fitting part of the other distribution connector.

2. The distribution cable connector according to claim 1, wherein the distribution connector further includes a connecting hook and an engagement part with which a connecting hook of another distribution connector is further engaged.

3. The distribution cable connector according to claim 1,
wherein the distribution connector has a structure that enables a plurality of distribution connectors to be fit one on top of another,
the fitting part of the distribution connector has a mechanism that locks a fitting state of the plurality of distribution connectors by a movable hook, and
the distribution connector has a mechanism that can attach and detach only the topmost distribution connector when the plurality of distribution connectors are fit one on top of another.

4. The distribution cable connector according to claim 2,
wherein the connecting hook is disposed on one of surfaces of the distribution cable other than a surface on a side on which the connection part of the distribution connector is disposed and a surface on a side opposite to the side on which the connection part is disposed, and
on the surface on the side opposite to the side on which the connection part of the distribution connector is disposed, a connecting hook retaining part is provided by which when another distribution connector is coupled, a connecting hook of the other distribution connector is retained.

5. A distribution connector that is connected to a cable and is used to connect the cable to a connection destination connector, the distribution connector comprising:
a connection part that is fit into the connection destination connector; and
a fitting part that is formed on a side opposite to a side on which the connection part is disposed and with which a connection part of another distribution connector can be engaged,
wherein the distribution connector is configured to be connected to the connection destination connector via the connection part of the distribution connector and to be coupled to another distribution connector through engagement with a fitting part of the other distribution connector.
